(19) United States
(12) Patent Application Publication
(10) Pub. No.: US 2002/0072887 A1
(43) Pub. Date: Jun. 13, 2002

(54) Interaction fingerprint annotations from protein structure models

(76) Inventors: Sandor Szalma, San Diego, CA (US); Mariusz Milik, San Diego, CA (US); Krzysztof Olszewski, San Diego, CA (US); Lisa Yan, San Diego, CA (US); Azat Badretdinov, San Diego, CA (US); Scott Kahn, Poway, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/933,580

(22) Filed: Aug. 20, 2001

Related U.S. Application Data
(60) Provisional application No. 60/226,327, filed on Aug. 18, 2000.

(51) Int. Cl. G06G 7/48

(52) U.S. Cl. 703/11

(57) ABSTRACT

A system and methods for rapidly and accurately assessing ligand binding characteristics for diverse classes of protein molecules. Modeling methods are used to represent the protein molecules and simulate their interaction with ligand molecules. Protein/ligand interactions are characterized by a fingerprint analysis that permits grouping of the proteins based on predicted structural features and ligand reactivity rather than sequence similarities or homology alone.

### CROSS REFERENCE TO RELATED APPLICATIONS

This application claims priority under 35 U.S.C. Section 119(e) to U.S. Provisional Application Serial No. 60/226,327, and filed on Aug. 18, 2000.

### BACKGROUND OF THE INVENTION

1. Field of the Invention

The invention relates to the field of protein analysis and more particularly to a system and method for predicting protein function.

2. Description of the Related Art

Genomic scale protein and gene identification projects continue to generate an ever-increasing number of sequences. Although the complete genomic sequence for a number organisms, including humans, is currently known, a substantial number of identified proteins and genes remain biochemically uncharacterized with little or no knowledge of their biological significance. To this end, current research efforts have begun to increasingly focus on the development of methods for characterizing, categorizing, and associating these sequences.

In an effort to advance knowledge of the biochemical function of expressed genes, large databases of sequence information have been made available. As shown in FIG. 1, such a system typically includes a genomics/proteonomics database 20 that stores information related to a plurality of proteins, nucleotides, or a combination thereof. The database 20 is further configured to interact with a bioinformatics search and computation engine 30 that retrieves and processes protein and/or nucleotide information from the database 20. One example of a currently commercially available genomics/proteonomics database and search/computation engine includes the GeneAtlas and AtlasStore products available from Accelrys in San Diego, Calif.

FIG. 2 illustrates one embodiment of data organization within the database 20. A plurality of entries 50 which describe and associate information with particular sequences is stored within the genomics/proteomics database 20. The entries 50 comprise an identifier 51, such as a name, accession number, or other reference that is associated with a particular sequence 60 that encodes a protein or portion of a protein molecule. The sequence 60 is further associated with one or more annotations or descriptors 65 used to store additional information about the sequence 60. The annotations 65 for the protein sequence 60 may be any of a number of different informational types and are representative of a characteristic, value, or property that is associated with the protein. Of the many possible types and combinations of annotations 65, some exemplary annotations include name descriptors (which may include the identifier 60), physical property characterizations (molecular weight, charge, shape, 3-D structure), chemical property characterizations (enzymatic activity, cofactors, turnover) as well as other annotation types.

The typical genome for even a relatively simple organism contains many thousands of genes, most of which are un-characterized and have not been previously investigated. Conventional experimental techniques used to assess these biological molecules are based largely on manual techniques and “wet chemistry” approaches and are limited with respect to the total number species which can be studied. The limited ability of these techniques to rapidly collect and associate biological and genetic information makes for slow and painstaking progress toward understanding the biological function of expressed genes and the genome as a whole.

More recently, computational characterization of gene and protein products has become of increasing interest to researchers as a method for performing research and analysis leading to more rapid identification and functional characterization of biological pathways and their component elements. However, when it comes to the computational analysis of the information present in genomic databases, the techniques available have been limited in power. For example, protein functional associations are typically conducted on the basis of sequence comparisons. Sequence homologies are analyzed in an attempt to identify functional analogy between proteins. This method of functional assessment is limited in its predictive ability and is not useful in comparing or identifying functional analogy between proteins that have different sequences. In the absence of further experimentation, these methods are restricted in their ability to provide useful functional information.

### SUMMARY OF THE INVENTION

In one embodiment, the invention comprises a method of deriving sequence annotations for sequences in a genomics or proteomics database by modeling the three dimensional structure of at least one protein encoded by a sequence in the database. Furthermore, the method comprises modeling an interaction between at least one ligand and the modeled three dimensional structure, and deriving an annotation from calculated characteristics of the interaction.

In another embodiment, the invention comprises a method of annotating sequences in a genomics or proteomics database by selecting a set of sequences from the database, obtaining a structural model of each protein encoded by the set of sequences, selecting a set of ligand molecules, separately modeling an interaction between each ligand and each structural protein model. Furthermore, the method comprises deriving a value indicative of the strength of interaction between each ligand molecule and each protein model, and storing the values in association with the sequences in the database.

In still another embodiment, the invention comprises a method of making a functional association between first and second protein molecules by retrieving a first series of values representative of binding strength between the first protein and a set of ligand molecules, retrieving a second series of values representative of binding strength between the second protein and the set of ligand molecules, and comparing the first series of values with the second series of values.

In a further embodiment, the invention comprises a computer readable medium storing a plurality of gene sequences, at least a first one of which has one or more annotations stored in association therewith, wherein the annotations comprise a set of values indicative of the predicted strength of binding between a protein encoded by the first gene sequence and a corresponding set of chemically diverse ligand molecules.

In a still further embodiment, the invention comprises a method of characterizing a protein by modeling an interaction between the protein and a ligand molecule. The method derives a value indicative of binding strength between the protein and the ligand molecule, repeats the modeling and derives for one or more additional ligand molecules, and stores the values as an associated set so as to form an interaction fingerprint characterizing chemical behavior of the protein.

In another embodiment, the invention comprises a method of comparing first and second protein molecules by retrieving a first set of values representative of binding strength between the first protein and a corresponding set of ligands. Furthermore, the method comprises retrieving a second set of values representative of binding strength between the second protein and the set of ligands, and comparing the first set of values to the second set of values.

In still another embodiment, the invention comprises a method of identifying a target protein for pharmaceutical intervention comprising the steps of: (a) selecting a first potential target protein, (b) retrieving a first interaction fingerprint comprising a set of values representative of binding strength between the potential target protein and a corresponding set of ligands, (c) retrieving a different interaction fingerprint comprising a set of values representative of binding strength between a different protein and the set of ligands, (d) comparing the first interaction fingerprint with the second interaction fingerprint and (e) repeating steps (c) and (d) for a plurality of different proteins encoded by a selected genome.

In yet another embodiment, the invention comprises a system for biological research comprising, a database storing both gene sequences and interaction fingerprints characterizing chemical behavior of at least some proteins encoded by the gene sequences, and a search and computation engine configured to retrieve and compare the interaction fingerprints.

In a still further embodiment, the invention comprises a method of assessing ligand interactions by selecting a ligand, and modeling the interaction of the ligand with a plurality of protein models spanning substantially an entire genome.

### BRIEF DESCRIPTION OF THE DRAWINGS

These and other aspects, advantages, and novel features of the invention will become apparent upon reading the following detailed description and upon reference to the accompanying drawings. In the drawings, same elements have the same reference numerals in which:

FIG. 1 is a prior art database of sequence information.

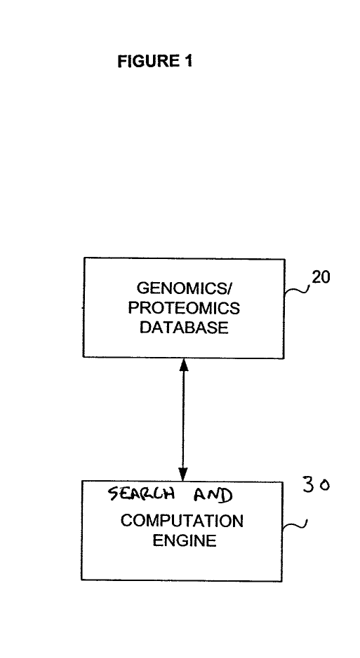

FIG. 2 illustrates a prior art schema for data organization within the database of sequence information of FIG. 1.

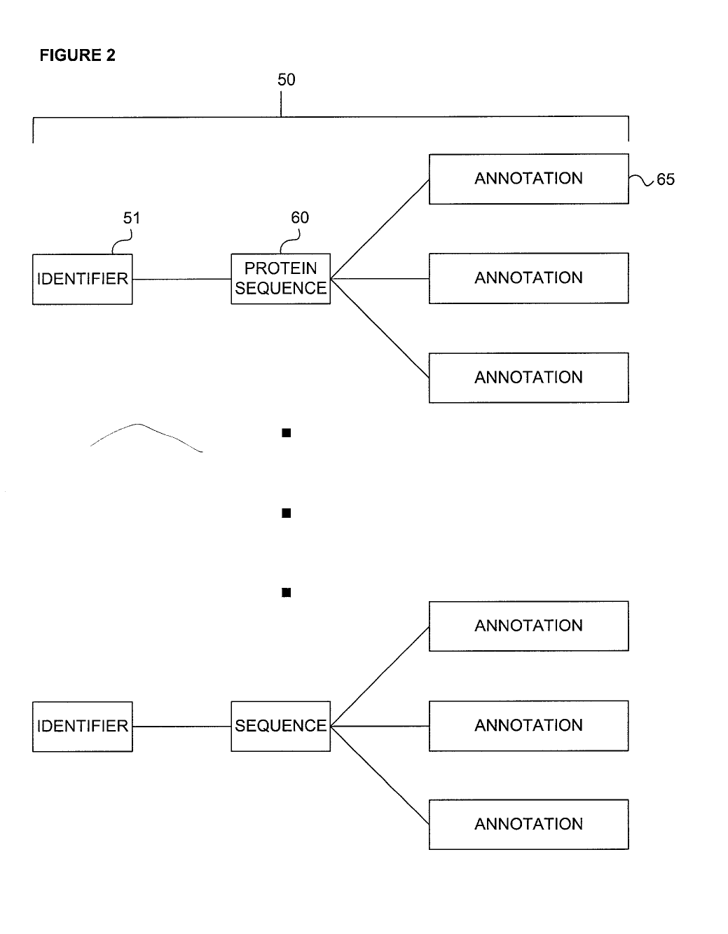

FIG. 3 illustrates a method for annotating entries in a genomic/proteomic database.

FIG. 4 illustrates a process for calculating ligand interaction annotations.

FIG. 5 illustrates exemplary ligand interaction annotation sets for two proteins.

### DETAILED DESCRIPTION OF THE PREFERRED EMBODIMENT

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

The present invention relates to systems and methods for utilizing models of protein structures to produce structure derived annotations useful in identifying analogies in function and/or chemical behavior between proteins. The annotations are derived from a variety of categories of structural information and provide a novel mechanism for characterization of expressed protein.

The methods of characterization and annotation presented herein provide improved protein characterization capabilities over conventional characterization methodologies that typically rely heavily on sequence-based comparisons. This method is also particularly useful in determining associations between dissimilar proteins that may have functional or behavioral analogies which are not obvious due to differences in the protein sequence.

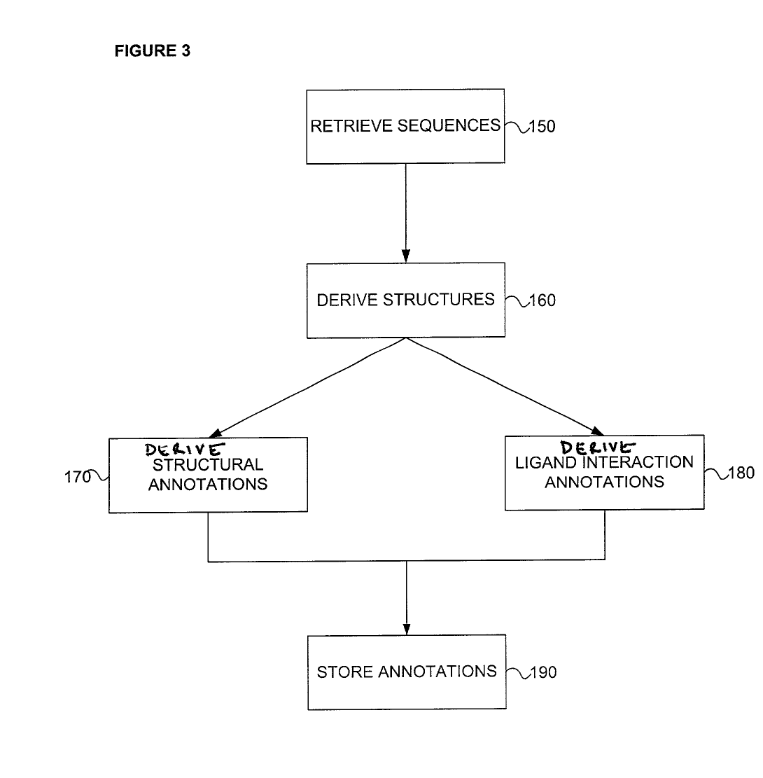

FIG. 3 illustrates one advantageous method for annotating entries contained in a genomic/proteomic database using annotations resulting from protein modeling and protein/ligand interaction simulations. The method starts at block 150 where sequences encoding expressed proteins are retrieved from a genomics database. Using the stored sequence information, three-dimensional protein structures are derived at block 160 using any of a variety of structural derivation/prediction methods well known to those in the art. These methods may include energy minimizing protein folding methods, comparisons to known structures having similar sequences, etc. In some cases, a relevant protein structure may be or may have been experimentally established, thus eliminating the need to produce a predicted structure from sequence or other information.

Once a three dimensional structure has been derived, a plurality of ligand interaction annotations are created at block 180 based upon a docking simulation between each modeled protein and each one of a series of selected ligands. Creation and use of ligand interaction annotations will be described in further detail below. In some embodiments of the invention, plurality of structural annotations are also created at block 170 which describe various structural features and/or properties of the protein molecule. The structural annotations may include one or more of the following: a shape pattern annotation, an active/binding site annotation, or an electrostatic field pattern annotation.

At block 190, the collection of derived annotations, including ligand interaction annotations and structural annotations (if any), are stored within the genomics/proteomics database 20 for subsequent retrieval and analysis.

1. Creation of Interaction Fingerprint

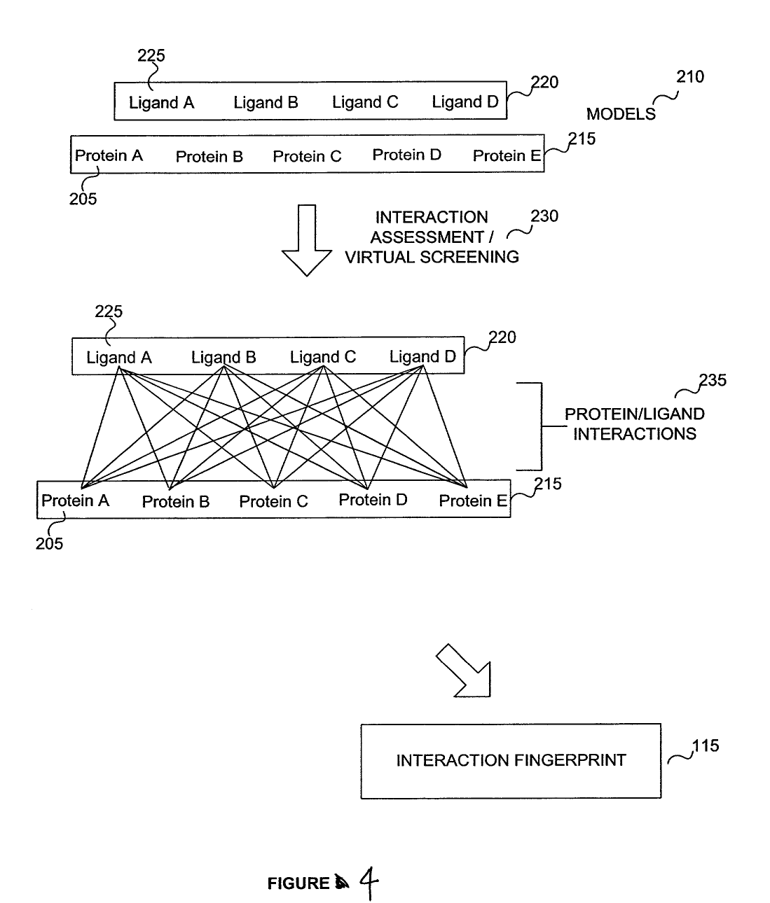

FIG. 4 illustrates an advantageous process for calculating ligand interaction annotations. In this process, a plurality of proteins or protein fragments 205 which are encoded by selected genetic sequences are identified, and each protein 205 is represented by a three dimensional structural model 210. As mentioned above, the model 210 of the protein 205 may be predicted computationally or determined in whole or in part based on experimental information. For example, x-ray crystallographic information may be used to identify the protein structure and provide necessary information used in the construction of the structural model of the protein 205. Typically, the protein model 210 will be obtained using information derived from nucleotide sequences which code for the amino acid sequence of the protein or protein fragment 205.

The plurality of protein models 210 form a protein modeling set 215, shown by way of example in FIG. 4 as being composed of Proteins A, B, C, D, and E. The modeling set 215 may comprise protein models 210 describing the constituent proteins from a partial or complete genome in a particular organism. In one embodiment of the invention, models are derived for every expressed sequence of the human genome.

In the reverse high-throughput screening process 200, a ligand set 220 is further identified which contains a plurality of modeled ligand molecules 225 whose interaction with the plurality of proteins 205 in the protein modeling set 215 is to be characterized. The type of the ligand molecules 225 may be any of a number of different compositions and may include for example, organic molecules, inorganic molecules, ions, proteins, protein fragments, nucleotides, RNA, DNA or other molecules. In one advantageous embodiment, the ligand set is a chemically diverse set of organic molecules.

Upon formation of the protein modeling set 215 and the ligand set 225, an interaction assessment or virtual screening assessment 230 is performed. Virtual assessment 230 entails modeling the interaction of each ligand 225 with each of the proteins 205 in the protein modeling set 215. In the example shown in FIG. 4, the virtual assessment 230 comprises simulating the interaction between the four ligands (Ligands A-D) and the five proteins (Proteins A-E) and results in a total of twenty protein/ligand interactions which are modeled.

The protein/ligand interaction comparisons 235 comprise identifying the nature of ligand interaction with each protein 205 in the comparison. Typically, the protein/ligand interactions are characterized by a bonding affinity between each protein 205 and each ligand 225. This could be a binary characterization, e.g. does the ligand bind or not, or it could be a numerical variable such as an estimate of an equilibrium binding constant or binding energy value.

Using the information obtained from the interaction assessment 230, a plurality of annotations are associated with each protein 205. The plurality of annotations for each protein 205 further form a pattern of interactions which may be used to compare or distinguish the proteins 205 from one another on the basis of the calculated ligand interactions. Using the fingerprint 115 as a metric for comparison, proteins 205 may be structurally or functionally associated when they share commonalities in the interaction fingerprints 115. This feature of the high-throughput modeling process 200 provides a powerful mechanism to associate proteins which does not rely on sequence or homology matching/comparisons alone, and which is useful in predicting how seemingly dissimilar proteins may be functionally related.

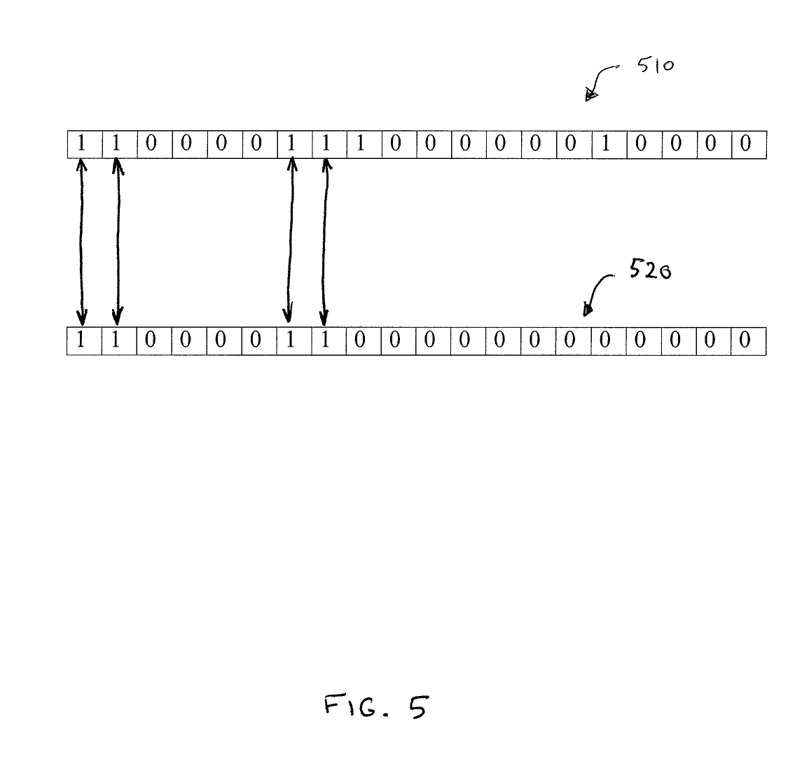

FIG. 5 illustrates an set of annotations for a first protein which form a first vector 510 of ligand interaction information. This vector may be referred to as an “interaction fingerprint” for the protein. In this example, the vector comprises a series of binary values, each one of which is representative of the presence or absence of binding between one of the test ligands and the protein. In the example of FIG. 5, a set of twenty ligands is used, although it will be appreciated that more or fewer than twenty may be used. A value of 1 in the vector denotes that the corresponding ligand will bind to the protein. A second vector 520 is also obtained for a second protein after docking simulations with the same set of test ligands.

When the two vectors are aligned and compared, it can be seen that the two proteins bind to four common ligands. An “overlap” computation may therefore be performed which comprises a vector multiplication where corresponding entries are multiplied, and the results summed to form a scalar output value. In the example of FIG. 5, the scalar output is 4. It may be useful to normalize this by dividing by the square root of the number of 1s in the first vector 510 times the number of 1s in the second vector 520. A normalized overlap value in this example is therefore slightly less than 0.8. It will be appreciated that analogous overlap values may also be computed if numerical variables such as estimated binding constants are used instead of binary 1 and 0 values.

2. Uses of the Interaction Fingerprint

a. Protein Functional Associations

This overlap value may be used as an indication of protein similarity in the same way that sequence homology is used. Normalized overlap values closer to one indicate proteins with similar chemical response. Overlap values closer to zero indicate proteins with divergent chemical response. These overlap values provide a valuable supplement to sequence homologies because the chemical behavior of two proteins may be similar even if their sequences are quite different. The interaction fingerprints can therefore be used to resolve ambiguous function assignments and improve the accuracy of functional annotation transfer from one sequence to another in a genomic database.

b. Toxicity Assessment

Qualified drug candidates can be evaluated for toxicity by comparing the protein which is the target of the drug candidate to other proteins in the human genome. In this application, the interaction fingerprint of the target protein is compared with the interaction fingerprint of other proteins, typically all or substantially all other proteins, in the human genome. Proteins that share a similar interaction fingerprint to the drug substrate may be identified as possible sources of undesirable side effects of the drug candidate.

Another form of toxicity assessment may be performed which may be termed “reverse high throughput screening.” In this method, a drug candidate is tested for binding affinity to substantially all of the modeled proteins of a desired genome. For example, a drug candidate with known or suspected desirable pharmaceutical activity is screened for affinity against substantially every expressed gene sequence in the human genome. Modeled binding events discovered during this screening process are possible sources of undesirable side effects. It will be appreciated that this is a reversal of conventional high throughput screening, where hundreds or thousands of ligands are tested for affinity to a single protein target. This procedure can be highly useful in drug discovery. For example, if a set of lead compounds have been identified, further testing can be focused on those leads which show the highest target selectivity and least likelihood of toxicity, thus reducing the amount of resources used to follow up on initially promising leads that later fail due to toxicity problems. A further benefit of performing this analysis is that an additional ligand interaction annotation can be added to the database for each protein, expanding the coverage of the stored interaction fingerprints.

c. Identification of Targets for Pharmaceutical Intervention

A variety of methods of fingerprint analysis can be used to improve the process of selecting targets for pharmaceutical intervention. The methods can be used to minimize the chances of selecting candidates having adverse side effects.

In one embodiment, a biochemical pathway is identified for intervention. As one example, a metabolic pathway in a disease pathogen may be selected which involves the activity of ten different proteins. If any of these ten proteins are inactivated, the biochemical chain will be broken and the pathogen will be killed. With interaction fingerprint annotations, the interaction fingerprint overlap of each of these ten proteins with each protein of the human genome may be determined. To minimize the potential for adverse side effects, the ten proteins in the pathogen's metabolic pathway may be ranked according to their average chemical response similarity to the proteins of the human genome. They may also be ranked according to the maximum chemical response overlap found with any human protein. The proteins in the pathogen's metabolic pathway with lower average and/or maximum overlaps to human proteins are then identified as the best candidates for pharmaceutical intervention because a ligand which inactivates one of these pathogen proteins is less likely to bind to human proteins with resulting undesired side effects.

d. Chemical Family Identification for Drug Candidates

Once a protein target for pharmaceutical intervention has been identified, its chemical fingerprint can be analyzed to see if it tends to bind to ligands in a particular chemical family. The chemical fingerprint for a particular protein may, for example, indicate that sulfones tend to interact with the protein. In this case, drug discovery can be focused on candidates in the indicated family first, leading to faster identification of specific molecules with the desired pharmaceutical activity.

e. Selectivity Identification

Interaction fingerprints may also be used to focus drug discovery on molecules in chemical families that are more likely to exhibit a specific desired pharmaceutical activity without exhibiting other activities. For example, a family of related proteins may have been previously functionally characterized, and it may be desirable to inactivate one of these proteins in a specific biochemical pathway. Members of the kinase family are one possible example. Kinases are involved in a wide variety of biochemical reactions, a specific one of which may be the target of drug discovery research. Because the proteins in this family are functionally related, many members of the family are likely to have similar interaction fingerprints. However, there are still likely to be differences between them. The interaction fingerprints may advantageously be analyzed to identify a chemical family of ligands that is preferentially bound to the target, but not highly bound to other members of the protein family.

f. Protein Family Profiling

Biological research on proteins making up a functionally related family can also be facilitated with the added information provided by the interaction fingerprints. Subfamilies can be identified and family trees can be constructed based upon interaction fingerprint overlaps of the different family members. In this application, the interaction fingerprint overlaps are analyzed an a manner analogous to sequence homologies in phylogenetic profiling.

As previously described, acquisition and analysis of the interaction fingerprint pattern produced by modeled protein/ligand interactions has numerous areas of application. The information obtained from the protein/ligand interaction assessments can be used in data mining applications to determine associations and relationships between diverse classes of both proteins and ligands to reveal previously unknown functional or structural similarities. In addition, drug discovery may be facilitated by increasing the likelihood of selective activity of leads, and by reducing the chance that a qualified candidate will exhibit toxic or otherwise adverse side effects.

Although the foregoing description of the invention has shown, described and pointed out novel features of the invention, it will be understood that various omissions, substitutions, and changes in the form of the detail of the system and methods as illustrated may be made by those skilled in the art without departing from the spirit of the present invention. Consequently the scope of the invention should not be limited to the foregoing discussion but should be defined by the appended claims.

What is claimed is:

1. A method of deriving sequence annotations for sequences in a genomics or proteomics database, said method comprising:
modeling the three dimensional structure of at least one protein encoded by a sequence in said database;
modeling an interaction between at least one ligand and said modeled three dimensional structure; and
deriving an annotation from calculated characteristics of said interaction.

2. The method of claim 1, wherein said sequences comprise nucleic acid sequences.

3. The method of claim 1, wherein said sequences comprise amino acid sequences.

4. A method of annotating sequences in a genomics or proteomics database, said method comprising:
selecting a set of sequences from said database;
obtaining a structural model of each protein encoded by the set of sequences;
selecting a set of ligand molecules;
separately modeling an interaction between each ligand and each structural protein model;
deriving a value indicative of the strength of interaction between each ligand molecule and each protein model; and
storing the values in association with the sequences in the database.

5. The method of claim 4, wherein said value is binary.

6. The method of claim 4, wherein the ligand molecules making up said set are chemically diverse.

7. A method of making a functional association between first and second protein molecules, said method comprising:
retrieving a first series of values representative of binding strength between said first protein and a set of ligand molecules;
retrieving a second series of values representative of binding strength between said second protein and said set of ligand molecules;
comparing said first series of values with said second series of values.

8. A computer readable medium storing a plurality of gene sequences, at least a first one of which has one or more annotations stored in association therewith, wherein said annotations comprise a set of values indicative of the predicted strength of binding between a protein encoded by said first gene sequence and a corresponding set of chemically diverse ligand molecules.

9. A method of characterizing a protein, said method comprising:
modeling an interaction between said protein and a ligand molecule;
deriving a value indicative of binding strength between said protein and said ligand molecule;
repeating said modeling and deriving for one or more additional ligand molecules; and
storing said values as an associated set so as to form an interaction fingerprint characterizing chemical behavior of said protein.

10. A method of comparing first and second protein molecules, said method comprising:
retrieving a first set of values representative of binding strength between said first protein and a corresponding set of ligands;
retrieving a second set of values representative of binding strength between said second protein and said set of ligands; and
comparing said first set of values to said second set of values.

11. The method of claim 10, wherein said values are binary indications of the either the presence of binding or the absence of binding.

12. The method of claim 10, wherein said comparing comprises multiplying values in each set corresponding to the same ligand.

13. A method of identifying a target protein for pharmaceutical intervention comprising:
(a) selecting a first potential target protein;
(b) retrieving a first interaction fingerprint comprising a set of values representative of binding strength between said potential target protein and a corresponding set of ligands;
(c) retrieving a different interaction fingerprint comprising a set of values representative of binding strength between a different protein and said set of ligands;
(d) comparing said first interaction fingerprint with said second interaction fingerprint;
(e) repeating steps (c) and (d) for a plurality of different proteins encoded by a selected genome.

14. The method of claim 13, wherein steps (c) and (d) are repeated for substantially all proteins encoded by said selected genome.

15. The method of claim 14, wherein said selected genome is the human genome.

16. A system for biological research comprising:
a database storing both gene sequences and interaction fingerprints characterizing chemical behavior of at least some proteins encoded by said gene sequences; and
a search and computation engine configured to retrieve and compare said interaction fingerprints.

17. A method of assessing ligand interactions, said method comprising:
selecting a ligand; and
modeling the interaction of the ligand with a plurality of protein models spanning substantially an entire genome.

18. The method of claim 17, further comprising:
selecting n additional ligands, where n is an integer of one or more; and
modeling the interaction of the n additional ligands with said plurality of protein models spanning substantially an entire genome.

19. The method of claim 17, wherein said ligand is a drug candidate that is tested for toxic response by assessing the modeled protein/ligand interactions.
